(19) United States
(12) Patent Application Publication
(10) Pub. No.: US 2026/0110992 A1
(43) Pub. Date: Apr. 23, 2026

(54) METHOD FOR OPERATING A CONTROLLER, COMPUTER PROGRAM PRODUCT AND CONTROLLER, AND MOTOR VEHICLE CONTAINING SAID CONTROLLER

(71) Applicant: Ford Global Technologies, LLC, Dearborn, MI (US)

(72) Inventors: Urs CHRISTEN, Aachen (DE); Mohsen LAKEHAL-AYAT, Aachen (DE)

(21) Appl. No.: 19/361,457

(22) Filed: Oct. 17, 2025

(30) Foreign Application Priority Data
Oct. 18, 2024 (DE) 102024130279.8

(51) Int. Cl. G05B 13/02; B60W 30/02

(52) U.S. Cl. CPC G05B 13/022; B60W 30/02

(57) ABSTRACT

A method for operating a controller for closed-loop control of a controlled system may include importing a variable value which influences a frequency response of the controlled system, determining a transformation factor as a function of the imported variable value, and performing an adaptation of the controller to the modified frequency response of the controlled system using the determined transformation factor.

### TECHNICAL FIELD

Example embodiments generally relate to a method for operating a controller, to a computer program product and to a controller, and to a motor vehicle containing said controller.

### BACKGROUND

In many systems it is necessary to control resonance phenomena in order to guarantee system stability. In vibratory systems, there can be a propensity to insufficiently damped vibrations in the region of the resonant frequency. Examples from the automotive sector are chassis, structural vibrations or noises, or even trailer operation under certain conditions. It is also the case, however, that other components, for instance pneumatic, hydraulic or electrical components, can have a propensity to insufficiently damped vibrations in the region of the resonant frequency. In many of these cases, the resonant frequency depends on one or a few parameters, which can be measured or estimated. For example, in the case of a chassis, this is the payload. The total mass of the motor vehicle can be estimated continuously, so that it is known. Then, for example, a controller for a semi-active chassis could be adapted.

U.S. Pat. No. 5,127,533 A discloses a method for operating a controller, in which the damping of a load sway is improved by adapting a sampling frequency of the controller when the cable length varies.

### BRIEF SUMMARY OF SOME EXAMPLES

The disclosure relates to demonstrating further ways in which a controller can be adapted to changes in the resonant frequency resulting from a variable value.

This may be achieved by a method for operating a controller for closed-loop control of a controlled system, having the steps including: importing a variable value which influences a frequency response of the controlled system; determining a transformation factor as a function of the imported variable value; and performing discretization of a state space representation of the controller using the determined transformation factor to adapt the controller to the modified frequency response of the controlled system.

Thus a variable value of a frequency response, for instance the position of one or more resonant frequencies of the controlled system, which were determined in advance, is imported, a transformation factor is determined, and the controller is adapted using the transformation factor.

The controller, in particular its bandwidth, can be adapted in this way to the modified frequency response of the controlled system, in particular to its altered resonant frequency.

Thus it is the controller itself that is adapted to the modified bandwidth rather than a sampling frequency at which a signal waveform of the system is sampled.

A controller can be adapted in this way to changes in the resonant frequency resulting from a variable value.

It is thereby possible to adapt controllers of a semi-active chassis to a modified frequency response of the controlled system. It is thereby also possible, however, to adapt controllers to other controlled systems, where the controlled system is any vibratory system.

According to one embodiment, the adapting of the controller comprises discretization of a state space representation of the controller. A state space representation is understood to mean here a system description, for example of a linear time-invariant transmission system. All the relationships between the input variables, output variables and state variables are represented in the form of matrices and vectors. The state space representation comprises two equations: a first-order state differential equation and an output equation.

The controller can be adapted in this way particularly easily to changes in the resonant frequency resulting from a variable value.

It is also possible, however, to dispense with discretization of the state space representation of the controller and instead, for example, adapt a discrete system matrix and a discrete input matrix directly using the transformation factor.

This can simplify even further the adaptation of the controller to changes in the resonant frequency.

According to a further embodiment, the discretization is performed using a Tustin formula. This allows the use of a robust controller such as a Hoo controller.

According to a further embodiment, the imported value is indicative of a payload. The payload can be, for example, the payload of a motor vehicle, which modifies the suspension behavior or damping behavior and hence the frequency response of a chassis of the motor vehicle. Such a payload can be determined, for example, during start-up of the motor vehicle. Start-up refers here to start-up before beginning a journey, for instance switching on the ignition. It is thereby possible, for example, to improve the damping of the chassis of the motor vehicle.

The invention also relates to a computer program product and to a controller, and to a motor vehicle containing said controller.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a schematic representation of a motor vehicle according to an example embodiment;

FIG. 2 shows a schematic representation of components of a model of a chassis of the motor vehicle shown in FIG. 1;

FIG. 3 shows a schematic representation of components of a control loop of the motor vehicle shown in FIG. 1;

FIG. 4 shows a schematic representation of a method flow according to a first exemplary embodiment for operating the motor vehicle shown in FIG. 1;

FIG. 5 shows a schematic representation of a method flow according to a second exemplary embodiment for operating the motor vehicle shown in FIG. 1; and

FIG. 6 shows a schematic representation of a method flow according to a third exemplary embodiment for operating the motor vehicle shown in FIG. 1.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other. It should be noted that the features and measures presented individually in the following description can be combined in any technically feasible manner, giving rise to further embodiments of the invention. The description additionally characterizes and specifies aspects of some example embodiments, particularly in conjunction with the figures.

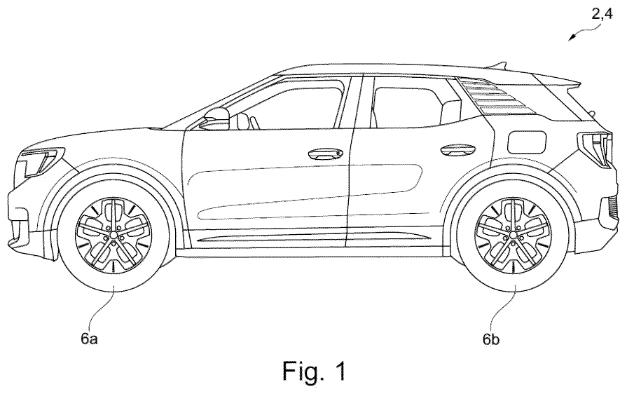

Reference is made first to FIG. 1, which shows a motor vehicle 2. In the present exemplary embodiment, the motor vehicle 2 is a car. As a variant of the present exemplary embodiment, the motor vehicle 2 can also be another land vehicle, for example a commercial vehicle such as a truck or bus. The motor vehicle 2 has a chassis 4. The chassis 4 refers here to all the components of the motor vehicle 2 that make a connection to the roadway via wheels 6a, 6b of the motor vehicle 2.

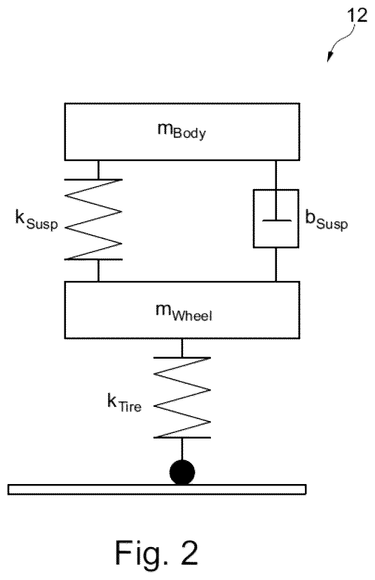

Reference is now also made to FIG. 2, which shows components of a ¼ model 12 of the chassis 4. The components are a vehicle mass m_{Body} of the motor vehicle 2 and a wheel mass m_{Wheel} of one of the wheels 6a, 6b, a spring constant K_{Susp} of a spring associated with the particular wheel 6a, 6b, and a spring constant K_{Tire} of one of the tires of the wheels 6a, 6b, and also a damping coefficient b_{Susp} of a damper associated with the particular wheel 6a, 6b.

The resonant frequency without payload fᵣ₀ of the ¼ model 12 decreases as the payload m_{Payload} increases, and the resonant frequency with the payload fᵣ is then given by:

$${f}_{r} = {f}_{r 0} \sqrt{\frac{{m}_{B o d y}}{{m}_{B o d y} + {m}_{P a y l o a d}}} \qquad ( eqn . 1 )$$

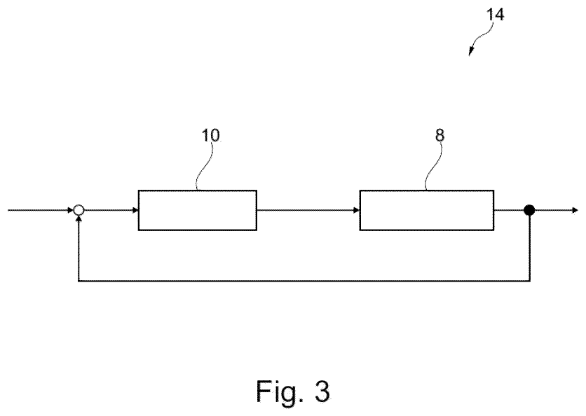

Reference is now also made to FIG. 3.

It shows components of a control loop 14 containing a controlled system 8 and a controller 10 of a, in the present exemplary embodiment, semi-active closed-loop damping control system of the chassis 4. Sensors detect actual driving states, and then an active intervention is made in the chassis tuning of the chassis 4 of the motor vehicle 2. This can improve the suspension and/or damping in the sense of improved driving comfort and/or higher driving safety.

The controlled system 8 in the present exemplary embodiment is based on the ¼ model of the chassis 4, while the controller 10 in the present exemplary embodiment is a robust controller such as a Hoo controller, for example.

In the present exemplary embodiment, the controller 10 is described by the following state space representation comprising a first-order state differential equation (eqn. 2) and an output equation (eqn. 3).

In the present exemplary embodiment, the controller 10 is described by the following state space representation comprising a first-order state differential equation (eqn. 2) and an output equation (eqn. 3).

$$\dot{x} = Ax + Bu \qquad ( eqn . 2 )$$

$$y = Cx + D u \qquad ( eqn . 3 )$$

According to a first exemplary embodiment, the two time-continuous state equations are discretized using the Tustin formula:

$$s \approx \frac{2}{{T}_{S}} \frac{z - 1}{z + 1} . \qquad ( eqn . 4 )$$

The system matrix A, input matrix B, output matrix C and feedthrough matrix D discretized in this way then read:

$$A = {( α I - A )}^{- 1} ( α I + A ) B = \sqrt{2 α} {( α I - A )}^{- 1} B C = \sqrt{2 α} {C ( α I - A )}^{- 1} D = D + {C ( α I - A )}^{- 1} B \qquad ( eqn . 5 a - 5 b )$$

with α=2/Tₛ₀, where a is a transformation factor and Tₛ₀ is the sampling time.

Thus the sampling time Tₛ₀ is kept constant but the transformation factor α is adapted to the payload m_{payload} according to the following equation:

$$α = \frac{2}{{T}_{s 0}} \sqrt{\frac{{m}_{B o d y}}{{m}_{Body} + {m}_{Payload}}} \qquad ( eqn . 6 )$$

The controller 10 can have suitably designed hardware and/or software components for this purpose.

As a variant of the present exemplary embodiment, a controller 10 as described above can be adapted to the modified frequency response of the controlled system 8 when the controlled system 8 is any vibratory system instead of the chassis 4 or the ¼ model 12.

According to a further exemplary embodiment, the dynamic behavior of a time-continuous controller is approximated as follows by time-discrete signals:

$$\dot{x} \approx \frac{{x}_{k + 1} - {x}_{k}}{{T}_{s}} = A {x}_{k} + B {u}_{k} \qquad ( eqn . 7 )$$

Resolving the equation eqn. 7 for x_(k+1) leads to:

$${x}_{k + 1} = ( {T}_{s} \underbrace{A +}_{A} I ) {x}_{k} + \underbrace{{T}_{s} B}_{B} {u}_{k} \qquad ( eqn . 8 )$$

The respective relationships for the discrete system matrix A_{adapt} and the discrete input matrix B_{adapt} can be inferred directly from this equation eqn. 8:

$${A}_{a dapt} = ( β ( A - I ) + I ) ; {B}_{a dapt} = β B \qquad ( eqn . 10 a - 10 b )$$

The corresponding output matrix C and feedthrough matrix D remain unchanged, however.

The further transformation factor β is obtained here as:

$$β = \sqrt{\frac{{m}_{Body} + {m}_{Payload}}{{m}_{Body}}} \qquad ( eqn . 11 )$$

The controller 10 can have suitably designed hardware and/or software components for this purpose.

Thus this dispenses with discretization of the state space representation of the controller 10. Instead, the discrete system matrix A_{adapt} and the discrete input matrix B_{adapt} are adapted directly using the transformation factor β.

As a variant of the present exemplary embodiment, a controller 10 as described above can be adapted to the modified frequency response of the controlled system 8 when the controlled system 8 is any vibratory system instead of the chassis 4 or the ¼ model 12.

According to a further exemplary embodiment, a sampling time Tₛ₀ of the controller 10 is adapted to the payload m_{payload}, in which a transformation factor γ

$$γ = \sqrt{\frac{{m}_{Body}}{{m}_{Body} + {m}_{Payload}}} \qquad ( eqn . 12 )$$

is determined, which is then used to determine a modified sampling time Ts:

$${T}_{s} = γ {T}_{s 0} \qquad ( eqn . 13 )$$

The controller 10 can have suitably designed hardware and/or software components for this purpose.

As a variant of the present exemplary embodiment, a controller 10 as described above can be adapted to the modified frequency response of the controlled system 8 when the controlled system 8 is any vibratory system instead of the chassis 4 or the ¼ model 12.

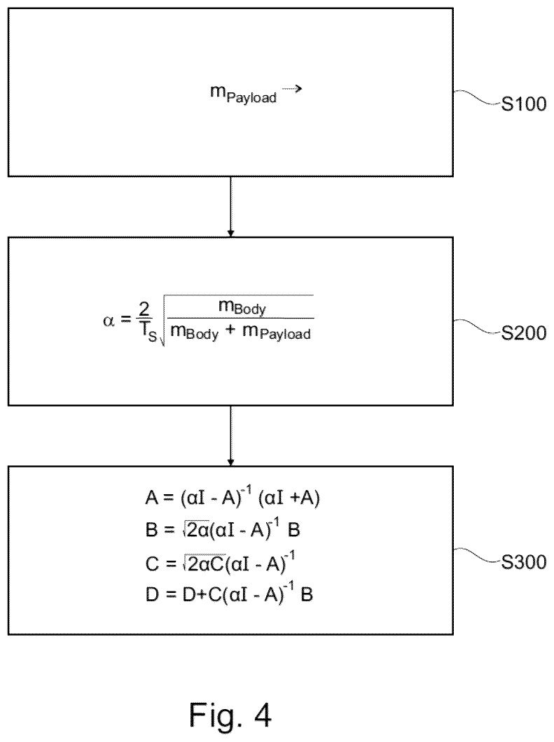

Reference is now also made to FIG. 4 in order to explain a method flow according to the first exemplary embodiment.

In a first step S100 in the present exemplary embodiment, the controller 10 imports the variable value, in the present exemplary embodiment the value indicative of the payload m_{Payload}.

In a further step S200 in the present exemplary embodiment, the controller 10 uses equation 6 to determine the transformation factor α as a function of, inter alia, the imported payload m_{Payload}.

In a further step S300 in the present exemplary embodiment, the controller 10 uses equations 5a-5d to perform the discretization of the state space representation given by equations 2 and 3 using, inter alia, the determined transformation factor a, in order to adapt thereby the controller 10 to the frequency response, modified by the payload m_{payload}, of the controlled system 8.

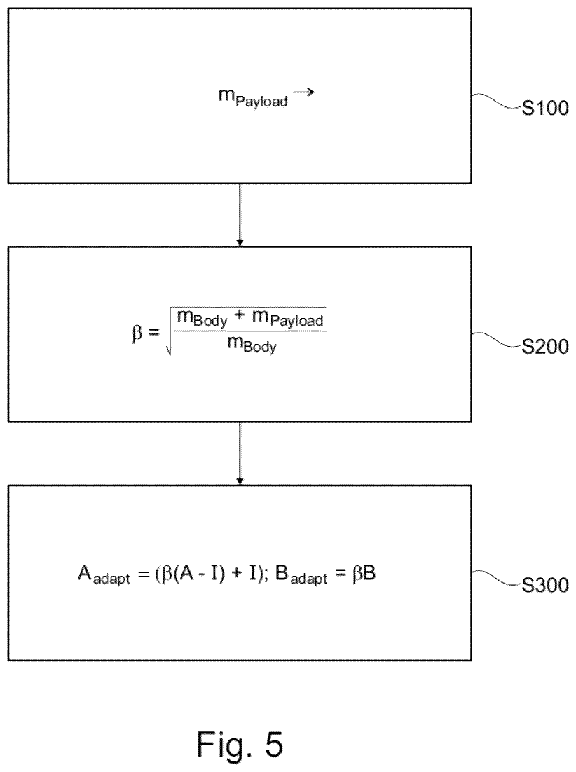

Reference is now also made to FIG. 5 in order to explain a method flow according to the second exemplary embodiment.

The first step S100 according to the second exemplary embodiment corresponds to the first step S100 according to the first exemplary embodiment.

In a further step S200 in the present exemplary embodiment, the controller 10 uses equation 11 to determine the transformation factor β as a function of, inter alia, the imported payload m_{Payload}.

In a further step S300 in the present exemplary embodiment, the controller 10 is adapted using equations 10a and 10b and the determined transformation factor β, in order to adapt thereby the controller 10 to the frequency response, modified by the payload m_{payload}, of the controlled system 8.

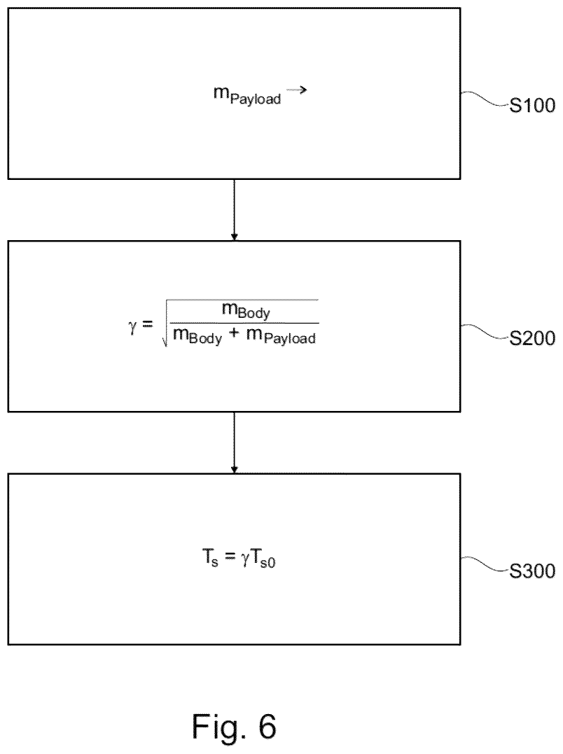

Reference is now also made to FIG. 6 in order to explain a method flow according to the third exemplary embodiment.

The first step S100 according to the third exemplary embodiment corresponds to the first step S100 according to the first exemplary embodiment.

In a further step S200 in the present exemplary embodiment, the controller 10 uses equation 12 or 13 to determine the transformation factor γ as a function of, inter alia, the imported payload m_{Payload}.

In a further step S300 in the present exemplary embodiment, the controller 10 is adapted using the determined transformation factor γ, in order to adapt thereby the controller 10 to the frequency response, modified by the payload m_{payload}, of the controlled system 8.

As an alternative to the present exemplary embodiment, the order of the steps may also be different. In addition, a plurality of steps can also be performed at the same time or simultaneously, Furthermore, as an alternative to the present exemplary embodiment, it is also possible to skip or omit individual steps.

A controller 10 can be adapted in this way to changes in the resonant frequency resulting from a variable value that influences the frequency response of the controlled system 8. The controlled system 8 can be the chassis 4 or the ¼ model 12 or any vibratory system.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A method for operating a controller for closed-loop control of a controlled system, the method comprising:
importing a variable value which influences a frequency response of the controlled system;
determining a transformation factor as a function of the imported variable value; and
performing an adaptation of the controller to the modified frequency response of the controlled system using the determined transformation factor.

2. The method of claim 1, wherein the adaptation of the controller comprises discretization of a state space representation of the controller.

3. The method of claim 2, wherein the discretization is performed using a Tustin formula.

4. The method of claim 1, wherein the imported value is indicative of a payload.

5. A computer program product comprising stored instructions in non-transitory memory that, when executed, perform the method of claim 1.

6. A controller for closed-loop control of a controlled system, wherein the controller is configured to import a variable value which influences a frequency response of the controlled system, to determine a transformation factor as a function of the imported variable value, and to perform an adaptation of the controller to the modified frequency response of the controlled system using the determined transformation factor.

7. The controller of claim 6, wherein the adaptation of the controller comprises discretization of a state space representation of the controller.

8. The controller of claim 7, wherein the controller is configured to perform the discretization using a Tustin formula.

9. The controller of claim 6, wherein the imported value is indicative of a payload.

10. A motor vehicle comprising the controller of claim 6.
